(19) United States
(12) Patent Application Publication
(10) Pub. No.: US 2025/0256415 A1
(43) Pub. Date: Aug. 14, 2025

(54) PERSONAL CARE DEVICE AND METHOD FOR DETERMINING A LOCATION OF THE PERSONAL CARE DEVICE ON A BODY PART

(71) Applicant: KONINKLIJKE PHILIPS N.V., EINDHOVEN (NL)

(72) Inventors: HARMEN ANDRIES KINGMA, ASSEN (NL); INGRID CHRISTINA MARIA, EINDHOVEN (NL); EELCO ARMINAK GALESTIEN, DRACHTEN (NL); JOOST WILLEM FREDERIK NENGERMAN, GRONINGEN (NL); EDDY GERRIT VELTMAN, STEENBERGEN (NL); WILLEM AUKE WESTERHOF, DRACHTEN (NL); MITSY PRADA HERRENO, EINDHOVEN (NL)

(21) Appl. No.: 18/881,900

(22) PCT Filed: Jul. 3, 2023
(86) PCT No.: PCT/EP2023/068135

§ 371 Date: Jan. 7, 2025

(30) Foreign Application Priority Data
Jul. 8, 2022 (EP) 22183812.1

(51) Int. Cl. B26B 19/38; B26B 19/14

(52) U.S. Cl. CPC B26B 19/388; B26B 19/14

(57) ABSTRACT

According to an aspect, there is provided a personal care device (2) for performing a personal care operation on a subject, the personal care device (2) being configured to determine a location of the personal care device (2) on a body part of the subject. The personal care device (2) comprises an orientation sensor (6) configured to measure a three-dimensional, 3D, angular orientation of the personal care device (2) relative to Earth's gravity over time and output a corresponding orientation measurement signal; a surface-displacement sensor (10) configured to measure a two-dimensional, 2D, displacement of the personal care device (2) relative to a skin surface of the body part and output a corresponding surface-displacement measurement signal; a processing unit (22) configured to determine the location of the personal care device (2) on the body part based on the orientation measurement signal, the surface-displacement measurement signal and a skin contact signal indicating whether the personal care device (2) is in contact with the skin surface of the body part.

### FIELD OF THE INVENTION

This disclosure relates to a personal care device for performing a personal care operation on a subject, and in particular relates to a method and apparatus for determining a location of the personal care device on a body part of the subject.

### BACKGROUND OF THE INVENTION

Personal care devices can be provided for a number of different types of personal care operation, such as shaving, hair clipping, photoepilation, skin massaging, etc. It can be useful for the location of the personal care device on the body of the subject to be determined in real-time or near real-time during the personal care operation. For example, knowledge of the location of the personal care device can be used to monitor the performance of the personal care operation, adjust operating characteristics of the personal care device, provide guidance to the user of the personal care device, etc.

A technique for determining the location of a personal care device is known from WO 2020/182698, in which a device for performing a treatment operation on the body part comprises one or more orientation sensors for measuring the orientation of the device, and one or more movement sensors for measuring the movement of the device. In this technique a three dimensional (3D) representation of the body part is obtained that has normal vectors for respective positions on the surface of the body part, the movement measurements and orientation measurements are processed to determine a sequence of positions and orientations of the device during the treatment operation and the sequence of orientations and positions of the device is compared to the normal vectors and respective positions of the normal vectors to determine the location of the device on the surface of the body part. However, while this technique enables a location of the device on the body part to be determined, higher accuracy of the determined location of a personal care device on a body part is desirable.

EP 3 800 644 A1 discloses a computer-implemented method of determining a location of a personal care device with respect to a skin surface of a subject. The method comprises receiving data representative of a measured curvature of the skin surface within a first region of the skin surface with which the personal care device is in contact. An indication of a location of the first region of the skin surface on the subject is determined by comparing the measured curvature with curvature information for a plurality of regions of the skin surface of the subject contained in a database. The location of the personal care device may be determined more accurately by acquiring additional data, such as displacement data of the personal care device acquired by a sensor, such as an inertial measurement unit (IMU). In some examples the IMU is used to estimate an orientation of the personal care device with respect to the gravity field to increase the location determination.

Therefore there is a need for improvements in the detection of the location of a personal care device during a personal care operation.

### SUMMARY OF THE INVENTION

According to a first specific aspect, there is provided a personal care device for performing a personal care operation on a subject, the personal care device being configured to determine a location of the personal care device on a body part of the subject. The personal care device comprises an orientation sensor configured to measure a three-dimensional, 3D, angular orientation of the personal care device relative to Earth's gravity over time and output a corresponding orientation measurement signal; a surface-displacement sensor configured to measure a two-dimensional, 2D, displacement of the personal care device relative to a skin surface of the body part and output a corresponding surface-displacement measurement signal; a processing unit configured to determine the location of the personal care device on the body part based on the orientation measurement signal, the surface-displacement measurement signal and a skin contact signal indicating whether the personal care device is in contact with the skin surface of the body part.

According to a second aspect, there is provided a computer-implemented method of determining a location of a personal care device on a body part of a subject, wherein the personal care device is configured for performing a personal care operation on the subject. The method comprises measuring, using an orientation sensor in the personal care device, a three-dimensional, 3D, angular orientation of the personal care device relative to Earth's gravity over time and outputting a corresponding orientation measurement signal; measuring, using a surface-displacement sensor in the personal care device, a two-dimensional, 2D, displacement of the personal care device relative to a skin surface of the body part and outputting a corresponding surface-displacement measurement signal; determining, by a processing unit, the location of the personal care device on the body part based on the orientation measurement signal, the surface-displacement measurement signal and a skin contact signal indicating whether the personal care device is in contact with the skin surface of the body part.

According to a third aspect, there is provided a computer program product comprising a computer readable medium having computer readable code embodied therein, the computer readable code being configured such that, on execution by a suitable computer or processor, the computer or processor is caused to perform the method according to the second aspect or any embodiment thereof.

These and other aspects will be apparent from and elucidated with reference to the embodiment(s) described hereinafter.

### BRIEF DESCRIPTION OF THE DRAWINGS

Exemplary embodiments will now be described, by way of example only, with reference to the following drawings, in which:

FIG. 1 is an illustration of an exemplary personal care device in the form of a rotary shaver;

FIG. 2 is a view of the top of the personal care device of FIG. 1;

FIG. 3 is a block diagram of a personal care device according to some embodiments;

FIG. 4 is a flow chart illustrating an exemplary method according to the disclosure; and

FIG. 5 is a block diagram illustrating some sub-steps of a location detection algorithm according to embodiments of the disclosure.

### DETAILED DESCRIPTION OF THE EMBODIMENTS

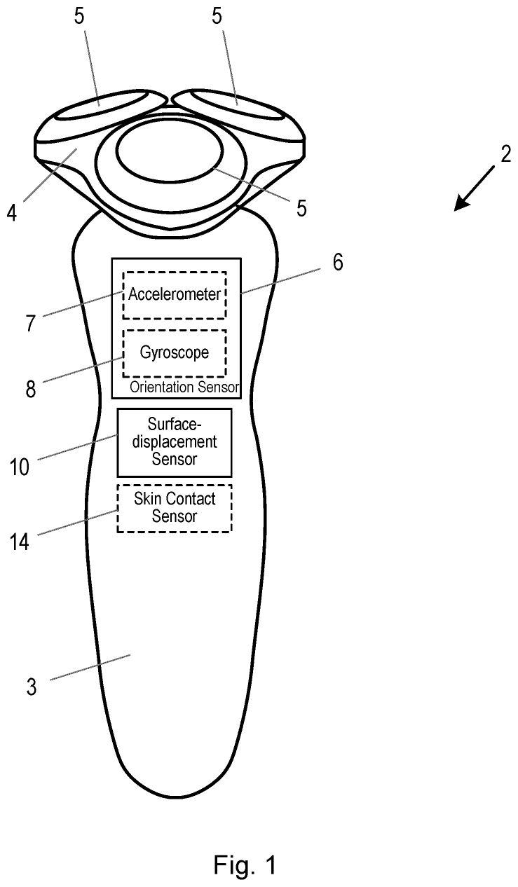

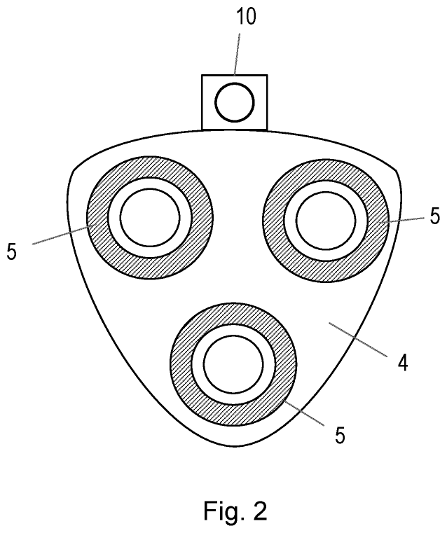

FIG. 1 is a simplified illustration of a personal care device 2 to which the techniques described herein can be applied or used with. FIG. 2 shows a top view of the personal care device 2 shown in FIG. 1. In FIG. 1 the personal care device 2 is in the form of an electric shaver/rotary shaver, but it will be appreciated that the techniques described herein can be applied to any type of personal care device 2, such as a foil shaver, a beard trimmer or any other type of hair-cutting device, a photoepilation device, a skin massager, a skin measurement device (e.g. for measuring characteristics of the skin), etc.

The personal care device 2 comprises a main body 3 that is to be held in a hand of a user and a cutting head 4 in the form of a shaving portion that includes a plurality of cutting elements 5 for cutting/shaving hair. Each cutting element 5 comprises one or more circular blades or foils (not shown in FIG. 1) that rotate rapidly. When the cutting head 4 is placed on the face and moved, hairs on the face are cut by the cutting elements 5. Although the cutting head 4 is shown in FIG. 1 as including three cutting elements 5 arranged in a triangle, it will be appreciated that a rotary shaver 2 can have a different number of cutting elements 5 and/or a different arrangement of cutting elements 5.

Various sensors present in or on the personal care device 2 are also shown in FIG. 1. Thus, FIG. 1 shows the personal care device 2 as comprising an orientation sensor 6, and a surface-displacement sensor 10.

The orientation sensor 6 is configured to measure a three-dimensional (3D) angular orientation of the personal care device 2 relative to Earth's gravity over time and output a corresponding orientation measurement signal representing the measured orientation. The orientation measurement signal comprises a time series of orientation measurement samples according to the sampling rate of the orientation sensor 6. In some embodiments, the orientation sensor 6 comprises a gyroscope 8, and optionally an accelerometer 7, and the orientation sensor 6 can also comprise a processor or processing unit for processing measurement signals provided by the accelerometer 7 and the gyroscope 8 to determine the orientation measurement signal. In some implementations the accelerometer 7 and gyroscope 8 are part of an inertial measurement unit (IMU) 12, but in other implementations the accelerometer 7 and gyroscope 8 are separate sensors.

The accelerometer 7 is configured to measure acceleration of the personal care device 2 over time along three axes, e.g. three orthogonal axes (i.e. in three-dimensions), and to output an acceleration measurement signal representing the measured (3D) acceleration. The acceleration measurement signal comprises a time series of acceleration measurement samples according to the sampling rate of the accelerometer 7. The measured acceleration will include acceleration due to gravity.

The gyroscope 8 is configured to measure rotation of the personal care device 2 over time around three axes, e.g. three orthogonal axes, and to output a gyroscope measurement signal representing the measured (3D) rotation. The gyroscope measurement signal comprises a time series of rotation measurement samples according to the sampling rate of the gyroscope 8.

The surface-displacement sensor 10 is configured to measure a two-dimensional (2D) displacement of the personal care device 2 relative to a skin surface of the body part and output a corresponding surface-displacement measurement signal representing the measured displacement. The surface-displacement measurement signal comprises a time series of surface-displacement measurement samples according to the sampling rate of the surface-displacement sensor 10. The surface-displacement sensor 10 may be an optical displacement sensor, similar to those used in computer mice. Thus, the surface-displacement sensor 10 can comprise a light source for emitting light on to the skin surface, and a light sensor or camera sensor for measuring the light reflected by the skin surface, with the surface-displacement measurement signal being derived from the measured light. For example, the surface-displacement sensor can comprise a low-resolution greyscale camera (e.g. with a resolution of 8×8 pixels, or 16×16 pixels) that captures images of the surface at a high or very high framerate, with surface displacement being calculated by analysing patterns in the captured images. The surface-displacement sensor 10 is arranged in the personal care device 2 so that the surface-displacement sensor 10 is able to observe and measure the skin surface when the personal care device 2 is in contact with the skin surface. As shown in FIG. 2, the surface-displacement sensor 10 can be arranged on or near to the cutting elements on the cutting head 4.

The orientation sensor 6, (and if present, the gyroscope 8 and the optional accelerometer 7) and surface-displacement sensor 10 are integral with, or otherwise in fixed positions within, the personal care device 2 so that movements of the personal care device 2 are directly measured by the orientation sensor 6 and surface-displacement sensor 10. The positions and orientations of the orientation sensor 6 (and if present, the gyroscope 8 and the optional accelerometer 7) and surface-displacement sensor 10 with respect to each other are known. In addition, the positions and orientations of the orientation sensor 6 (and if present, the gyroscope 8 and the optional accelerometer 7), and surface-displacement sensor 10 with respect to the part of the personal care device 2 that is in contact with the skin surface during the personal care operation is also known. For example, a calibration procedure may be performed during manufacture of the personal care device 2 or during initial set up or during product design, so that the relative positions and orientations are determined. The positions and orientations of the sensors with respect to the part of the personal care device 2 that is in contact with the skin surface during uses enables the measurements from the sensors to be related to the movements of the personal care device 2 relative to the skin surface.

As discussed further below, in determining the location of the personal care device 2 on the subject, it is useful to know whether the personal care device 2 is in contact with the skin surface. Therefore a skin contact signal is required that comprises measurements of whether the personal care device 2 is in contact with the skin surface of the body.

In some embodiments, the personal care device 2 can comprise a skin contact sensor 14 that is configured to measure whether the personal care device 2 is in contact with the skin surface of the body part and output the corresponding skin contact signal. The skin contact signal comprises a time series of skin contact measurement samples according to the sampling rate of the skin contact sensor 14. The skin contact sensor 14 may be a pressure (force) sensor that measures the pressure with which the personal care device 2 is being pressed on to a surface, a proximity sensor or a capacitive sensor. A proximity sensor can be based on any suitable technology, such as light, sound, ultrasound, etc., and make use of time of flight measurements to determine proximity of the sensor 14 to the skin surface (and thus proximity of the personal care device 2 to the skin surface since the position of the sensor 14 in the personal care device 2 is known). It will be appreciated that some types of skin contact sensor 14 may provide a binary output in the skin contact signal indicating whether the personal care device 2 is in contact with the skin surface at that instant.

In alternative embodiments, the personal care device 2 does not include a separate skin contact sensor 14 and instead the skin contact signal is derived by processing the surface-displacement measurement signal. For example, when the personal care device 2 is in contact with the skin surface, the surface-displacement sensor 10 will be able to measure displacement of the personal care device 2 over the skin surface, whereas when the personal care device 2 is not in contact with the skin, the surface-displacement sensor 10 will not be able to measure a surface displacement, and this can be identified from the surface-displacement measurement signal.

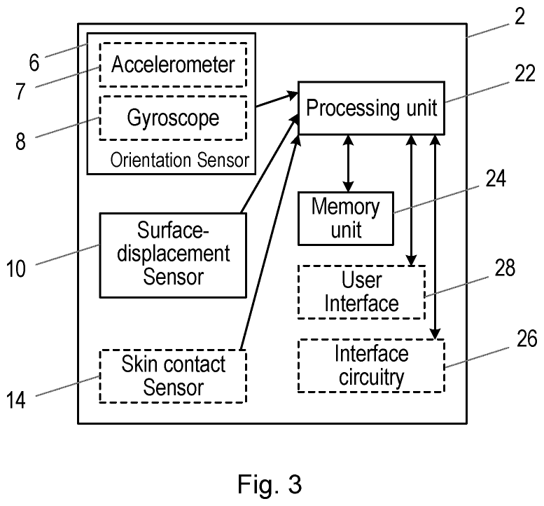

FIG. 3 is a block diagram of an exemplary personal care device 2 configured to determine a location of the personal care device 2 on a body part of a subject according to the techniques described herein. In the embodiments shown in FIG. 3, the processing performed to determine the location of the personal care device 2 is performed by a processing unit 22 inside the main body 3 of the personal care device 2. However, it will be appreciated that in alternative embodiments, the processing performed to determine the location of the personal care device 2 can be performed by a processing unit that is part of a base unit of the personal care device 2, e.g. a docking station or charging stand. In addition, where the orientation sensor 6 comprises an accelerometer 7 and a gyroscope 8, the processing unit 22 or a separate processor or processing unit comprised within or associated with the orientation sensor 6 can be provided for determining the orientation measurement signal.

The processing unit 22 generally controls the operation of the personal care device 2 and enables the personal care device 2 to perform the method and techniques described herein. Briefly, the processing unit 22 is configured to determine the location of the personal care device 2 on the body part based on the orientation measurement signal, the surface-displacement measurement signal and the skin contact signal.

The processing unit 22 is configured to receive the orientation measurement signal and the surface-displacement measurement signal from the respective sensors 6, 10. In embodiments where the personal care device 2 comprises a skin contact sensor 14, the processing unit 22 is also configured to receive the skin contact signal. Thus the processing unit 22 can include or comprise one or more input ports or other components for receiving the measurement signals from the sensors 6, 10, 12. The processing unit 22 can also include or comprise one or more output ports or other components for communicating with other components of the personal care device 2.

The processing unit 22 can be implemented in numerous ways, with software and/or hardware, to perform the various functions described herein. The processing unit 22 may comprise one or more microprocessors or digital signal processors (DSPs) that may be programmed using software or computer program code to perform the required functions and/or to control components of the processing unit 22 to effect the required functions. The processing unit 22 may be implemented as a combination of dedicated hardware to perform some functions (e.g. amplifiers, pre-amplifiers, analog-to-digital convertors (ADCs) and/or digital-to-analog convertors (DACs)) and a processor (e.g., one or more programmed microprocessors, controllers, DSPs and associated circuitry) to perform other functions. Examples of components that may be employed in various embodiments of the present disclosure include, but are not limited to, conventional microprocessors, DSPs, application specific integrated circuits (ASICs), and field-programmable gate arrays (FPGAs).

The processing unit 22 can comprise or be associated with a memory unit 24. The memory unit 24 can store data, information and/or signals (including measurement signals, any result or any intermediate result of the processing of the measurement signals) for use by the processing unit 22 in controlling the operation of the personal care device 2 and/or in executing or performing the methods described herein. In some implementations the memory unit 24 stores computer-readable code that can be executed by the processing unit 22 so that the processing unit 22 performs one or more functions, including the methods described herein. The memory unit 24 can comprise any type of non-transitory machine-readable medium, such as cache or system memory including volatile and non-volatile computer memory such as random access memory (RAM), static RAM (SRAM), dynamic RAM (DRAM), read-only memory (ROM), programmable ROM (PROM), erasable PROM (EPROM) and electrically erasable PROM (EEPROM), and the memory unit can be implemented in the form of a memory chip, an optical disk (such as a compact disc (CD), a digital versatile disc (DVD) or a Blu-Ray disc), a hard disk, a tape storage solution, or a solid state device, including a memory stick, a solid state drive (SSD), a memory card, etc.

In the embodiment shown in FIG. 3, the personal care device 2 further comprises interface circuitry 26 that enables a data connection to and/or data exchange with other devices, including any one or more of smartphones, laptops, smartwatches, computers, and other user devices. Any data connection may be direct or indirect (e.g. via the Internet), and thus the interface circuitry 26 can enable a connection between the personal care device 2 and a network, or directly between the personal care device 2 and another device (such as a smartphone), via any desirable wired or wireless communication protocol. For example, the interface circuitry 26 can operate using WiFi, Bluetooth, Zigbee, or any cellular communication protocol (including but not limited to Global System for Mobile Communications (GSM), Universal Mobile Telecommunications System (UMTS), Long Term Evolution (LTE), LTE-Advanced, etc.). In the case of a wireless connection, the interface circuitry 26 (and thus personal care device 2) may include one or more suitable antennas for transmitting/receiving over a transmission medium (e.g. the air). The interface circuitry 26 is connected to the processing unit 22.

The personal care device 2 may also comprise one or more user interface components 28 that enable a user of personal care device 2 to input information, data and/or commands into the personal care device 2, and/or enables the personal care device 2 to output information or data to the user of the personal care device 2, for example information indicating the performance of the personal care operation, a coverage of the personal care operation, and/or any other information related to, or derivable from, the determined location of the personal care device 2. The user interface 28 can comprise any suitable input component(s), including but not limited to a keyboard, keypad, one or more buttons, switches or dials, a mouse, a track pad, a touchscreen, a stylus, a camera, a microphone, etc., and/or the user interface 28 can comprise any suitable output component(s), including but not limited to a display unit or display screen, one or more lights or light elements, one or more loudspeakers, a vibrating element, etc.

It will be appreciated that a practical implementation of a personal care device 2 will include additional components to those shown in FIG. 3. For example, the personal care device 2 may also include a power supply, such as a battery, or components for enabling the personal care device 2 to be connected to a mains power supply, for example for charging the battery.

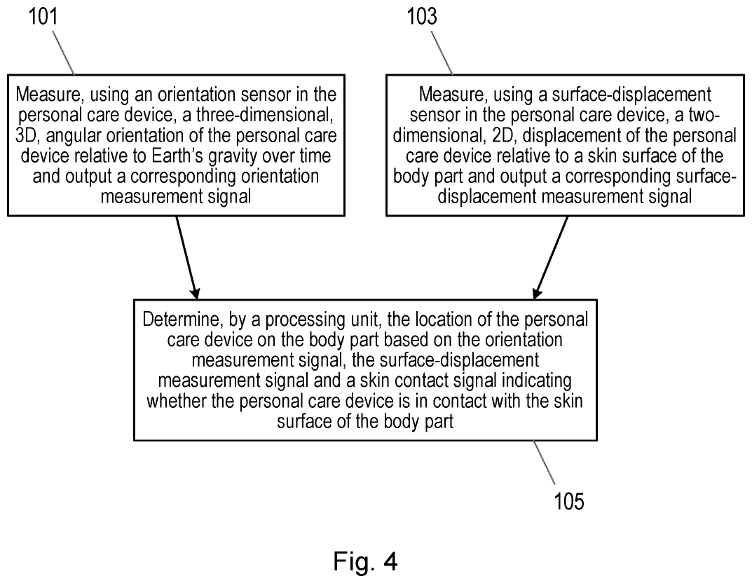

The flow chart in FIG. 4 illustrates an exemplary method performed by the personal care device 2 according to the techniques described herein. As noted above, the personal care device 2 is for performing a personal care operation on the subject, such as hair cutting, shaving, photoepilation, skin massaging, etc. The body part that the personal care operation is performed on can be the head of the subject, the face of the subject, or the head/face and neck of the subject.

In step 101, the orientation sensor 6 in the personal care device 2 measures 3D angular orientation of the personal care device 2 relative to Earth's gravity over time, and in particular during use of the personal care device 2 in performing the personal care operation. The orientation sensor 6 outputs an orientation measurement signal representing the measured orientation around three axes. The orientation sensor 6 outputs the orientation measurement signal continuously as the orientation is measured.

In step 103, the surface-displacement sensor 10 in the personal care device 2 measures a 2D displacement of the personal care device 2 relative to a skin surface of the body part over time, and in particular during use of the personal care device 2 in performing the personal care operation. The surface-displacement sensor 10 outputs a corresponding surface-displacement measurement signal representing the measured displacement. The surface-displacement sensor 10 outputs the surface-displacement measurement signal continuously as the surface-displacement is measured.

It will be appreciated that steps 101 and 103 take place simultaneously during use of the personal care device 2.

In step 105 the processing unit 22 determines the location of the personal care device 2 on the body part based on the orientation measurement signal, the surface-displacement measurement signal and a skin contact signal indicating whether the personal care device 2 is in contact with the skin surface of the body part. The processing unit 22 may perform step 105 in response to executing computer program code, that can be stored on a computer readable medium, such as, for example, the memory unit 24.

In some embodiments, a skin contact sensor 14 is provided to measure whether the personal care device 2 is in contact with the skin surface and to generate the skin contact signal, in which case the method further comprises the skin contact sensor 14 in the personal care device 2 measuring whether the personal care device 2 is in contact with the skin surface over time, and in particular during use of the personal care device 2 in performing the personal care operation. The skin contact sensor 14 outputs a corresponding skin contact signal representing whether the personal care device 2 is in skin contact or not. The skin contact sensor 14 outputs the skin contact signal continuously as the skin contact is measured. In alternative embodiments, a separate skin contact sensor 14 is not present in the personal care device 2, and the processing unit 22 is configured to process the surface-displacement measurement signal from the surface-displacement sensor 10 to determine the skin contact signal.

In embodiments where the orientation sensor 6 comprises an accelerometer 7 and a gyroscope 8, the accelerometer 7 measures the acceleration of the personal care device 2 over time, and the gyroscope 8 measures the rotation of the personal care device 2 over time, in particular during use of the personal care device 2 in performing the personal care operation. The accelerometer 7 generates an acceleration measurement signal representing the measured acceleration along 3 axes, and the gyroscope 8 generates a gyroscope measurement signal representing the measured rotation around 3 axes. The method can comprise determining the 3D angular orientation of the personal care device 2 (as represented by the orientation measurement signal) from the output signals of the 3-axis accelerometer 7 and the 3-axis gyroscope 8.

In some embodiments, in step 105 the processing unit 22 can be configured to estimate a starting location of the personal care device 2 on the skin surface of the body part. The processing unit 22 can use this starting location to determine the current location of the personal care device 2 on the skin surface. In particular, the processing unit 22 can determine the current location by processing the orientation measurement signal, surface-displacement measurement signal and skin contact signal to determine or estimate movement of the personal care device 2 from the starting location of the personal care device 2. The starting location can be estimated to be a default location on the skin surface. For example, the user of the personal care device 2 may always start the personal care operation on their right cheek (e.g. may start a shaving operation on their right cheek), or above their top lip, etc. Alternatively, the starting location may be determined by the processing unit 22 based on an average starting location detected during previous personal care operations. In another alternative, the starting location can be determined based on the orientation measurement signal. In this case, a geometric model of the body part can be used in combination with the orientation measurement signal in determining the starting location of the personal care device 2.

In some embodiments, step 105 comprises the processing unit 22 performing a location detection algorithm that comprises a number of sub-steps. Firstly, the processing unit 22 processes the skin contact signal to determine whether the personal care device 2 is in contact with the skin surface.

If it is determined that the personal care device 2 is not in contact with the skin surface, the processing unit 22 determines the location of the personal care device 22 on or relative to the body part from the orientation measurement signal.

Similarly, if it is determined that the personal care device 2 has resumed contact with the skin surface after a period of no contact with the skin surface, and before the surface-displacement measurement signal indicates that the personal care device 2 has moved relative to the skin surface, the processing unit 22 determines the location of the personal care device 2 on the body part from the orientation measurement signal.

However, if it is determined that the personal care device 2 is in contact with the skin surface, and the personal care device 2 has moved relative to the skin surface in continuous contact therewith since the personal care device 2 last resumed contact with the skin surface, the processing unit 22 determines the location of the personal care device 2 on the body part from the orientation measurement signal and the surface-displacement measurement signal.

In some embodiments, step 105 can comprise deriving from the orientation measurement signal a 3D angular orientation of a 2D reference plane of the surface-displacement sensor in which the 2D displacement of the personal care device 2 is measured. Then, the 2D displacement measurement represented by the surface-displacement measurement signal is combined with the 3D angular orientation of the 2D reference plane of the surface-displacement sensor to determine a 3D displacement of the personal care device 2 relative to the body part. Effectively, this processing converts the 2D displacement measurements by the surface-displacement sensor 10 into a 3D displacement of the personal care device 2 relative to the body part by taking into account the 3D angular orientation of the 2D reference plane in which the 2D displacement of the personal care device 2 relative to the skin surface is measured.

In some embodiments, the processing unit 22 can determine the location of the personal care device 2 on the body part by determining a first location estimate for the personal care device 2 from the surface-displacement measurement signal and the orientation measurement signal, e.g. in the manner as described here before, determining a second location estimate for the personal care device 2 from the orientation measurement signal, combining the first location estimate and the second location estimate to determine a filtered location estimate, determining a projection of the filtered location estimate onto a geometric model of the body part, and determining the location of the personal care device 2 on the body part from the projection. In some embodiments, the location of the personal care device 2 can be determined from an intersection of the projection of the filtered location estimate and the geometric model.

In embodiments where the orientation sensor 6 comprises an accelerometer 7 and a gyroscope 8, the orientation measurement signal can be determined as follows. The accelerometer 7 is capable of measuring the direction of gravity. Gravity appears in the measurements as a vector with a length of lg pointing towards the ground. This provides a reference that can be used to determine the orientation of the personal care device 2 with respect to Earth's gravity or the ground plane. However, the accelerometer 7 measures all accelerations, so also the ones caused by moving the personal care device 2 through space. Therefore, the gravity measurement is noisy and unstable in the short term, although on average it will point in the right direction. The gyroscope 8 is capable of measuring the device rotation around 3 axes. It is fast and accurate. However, it cannot measure the direction of gravity. So, an absolute personal care device 2 angular orientation with respect to Earth's gravity cannot be calculated using only a gyroscope. Furthermore, a gyroscope measurement signal contains small measurement errors. Relative angular orientation is calculated by integrating rotation speed over time. This relative angular orientation estimate will therefore drift away from the actual value over time due to measurement errors and cumulative integration errors. In order to combine strengths and overcome weaknesses, the outputs of both sensors 7, 8 are combined in a smart way. In essence, the accelerometer measurements are used to calculate a direction of Earth's gravity field or ground plane direction which is stable in the long term, and the gyroscope measurement signal is used to accurately track the fast short-term angular orientation changes. One way of doing this is to use a complementary filter which effectively applies a low-pass filter to a gravity direction signal derived from the accelerometer measurements and a high pass filter to the gyroscope measurement signal, and combines both filtered signals to obtain the final orientation measurement signal. It should be noted that two of the three components of the resulting orientation in the orientation measurement signal are absolute, the roll angle and the pitch angle. These axes are perpendicular to the direction of gravity so orientation changes of these axes can be measured by the accelerometer as a change in gravity direction. The yaw axis is in line with gravity so rotations along this axis do not show up as a change in gravity direction. This yaw axis can be considered as the axis running from the top of the head straight down, and therefore the personal care device left-right movement measurements are fully relative (gyroscope only). The foregoing is why a starting location should be set or derived. Without the starting location, the algorithm could, for example, assume the user started at the center of the face, while in reality they started on the right cheek.

Assuming that the start location of the personal care device 2 is known, the first location estimate can be a relatively accurate location of the personal care device 2 on the skin surface. However, without correction, over larger displacements the first location estimate drifts and the accuracy is reduced. Therefore, embodiments provide that the first location estimate and the second location estimate are combined to address this drift problem.

In some embodiments, the first location estimate and the second location estimate are combined using a complementary filter. The complementary filter can act as a combined high and low pass filter. In some embodiments, the complementary filter can operate such that the first location estimate (i.e. the location estimate determined from the surface-displacement measurement signal and the orientation measurement signal) is high-pass filtered, and the second location estimate (i.e. the location estimate derived from the orientation measurement signal) is low-pass filtered. The effect is that the first location estimate is slowly pulled towards the second location estimate, which keeps it from drifting away while still allowing the accurate short term surface displacement sensor information to pass through the filter.

In some embodiments, the geometric model of the body part mentioned above can also be used to correct for long term changes in orientation of the body part. The physical constraints defined by the model are used here to correct the location estimate. This mechanism can be used to correct the (fully relative) yaw angle measurement. The idea is that a person cannot turn their head left or right for more than 180°. When a person turns their head and not the personal care device 2, the orientation sensor 6 (IMU) will not measure this and the location estimate by the IMU (the second location estimate-the IMU-only location) will become incorrect. However, as the user will continue to shave, the measured IMU-only location will move out-of-bounds of the head model. This can be detected and the second location estimate can be moved in such a way that the resulting location lies inside the head model again. Similarly, when the user turns both their head and the personal care device 2, this will show up incorrectly as the personal care device 2 moving left/right across the face in the IMU-only location estimate. Again, the physical constraints of the head model can be used to correct the location estimate. For both of these methods, the correction will be complete as soon as the user fully covers the beard area from left to right after moving their head. As to the other 2 angles, it is assumed that the user keeps their head straight on average.

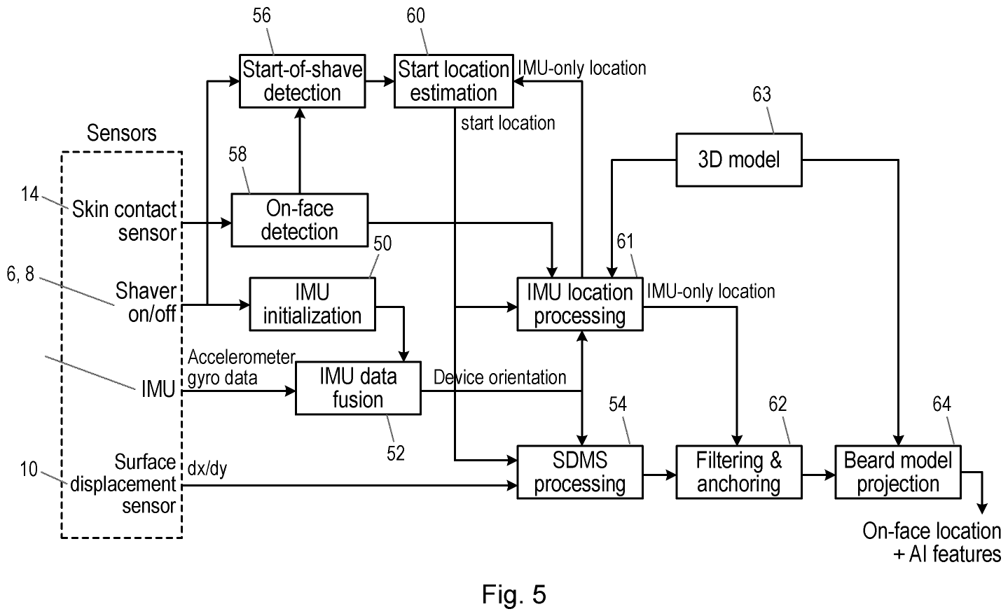

The block diagram in FIG. 5 illustrates some of the logical sub-steps of embodiments of the location detection algorithm described above. While FIG. 5 is directed to an embodiment where the personal care device 2 is an electric shaver and the personal care operation is shaving the face and neck, it will be appreciated that the sub-steps in FIG. 5 can be applied to other types of personal care device 2 and/or other types of personal care operation. In FIG. 5 the accelerometer 7 and the gyroscope 8 are considered to be part of an IMU. In addition, the electric shaver comprises a skin contact sensor 14.

Thus, in FIG. 5, when the electric shaver 2 is activated/switched on, the IMU 7, 8 is initialised (e.g. activated)—block 50—and an IMU data fusion block 52 is activated. The orientation sensor 6 can be considered to comprise the IMU and the IMU data fusion block 52. The output of the IMU namely the acceleration measurement signal (which indicates acceleration in three orthogonal directions (e.g. denoted ax, ay, az)) and the gyroscope measurement signal (which indicates rotation speed in three dimensions) are input to the IMU data fusion block 52. The output of the surface-displacement sensor 10, namely the surface-displacement measurement signal (which indicates displacement in two dimensions (e.g. denoted dx, dy) is input to a surface-displacement measurement signal (SDMS) processing block 54. The output of the skin contact sensor 14, the skin contact signal, is input to a block 58 that detects from the skin contact signal whether the electric shaver is in contact with the skin surface. Based on the output of block 58 and the status of the on/off button of the electric shaver, block 56 detects whether the shaving operation has started.

When block 56 detects that a shaving operation has started, a start location estimation block 60 is initialised to estimate the start location of the electric shaver. As noted above, the start location can be estimated as a default location for the electric shaver (e.g. right cheek), as an average of the start locations for a number of previous shaving operations, or based on the orientation measurement signal. The estimated start location is output to the SDMS processing block 54 and an IMU location processing block 61. The estimated start location can be used to initialise location estimates (e.g. the location estimate derived from the orientation measurement signal), and/or the location estimate derived from both the orientation measurement signal and the surface-displacement measurement signal. In some embodiments, the start location estimation block 60 can estimate the start location based on a location estimate determined by the IMU location processing block 61. The estimated start location can be always assumed to be in the face area, and during the shaving operation, the start location estimate can be corrected and updated based on the physical limits of the beard/facial hair area.

The IMU data fusion block 52 determines the orientation measurement signal, which is the 3-axis angular orientation in the global coordinate system (which is also referred to as “device orientation”) from the gyroscope measurement signal and the acceleration measurement signal. Thus, the IMU data fusion block 52 determines the orientation measurement signal representing the 3D angular orientation of the personal care device 2 relative to Earth's gravity during the personal care operation from the acceleration measurement signal and the gyroscope measurement signal. In particular, as described in detail here before, the acceleration measurement signal is used to calculate a ground plane direction which is stable in the long term, and the gyroscope measurement signal is used to accurately track the fast short-term orientation changes. Both signals are combined to obtain the 3D device orientation with respect to the ground plane (the orientation measurement signal). The IMU data fusion block 52 outputs the 3-axis orientation signal to the SDMS processing block 54 and to the IMU location processing block 61.

In some embodiments, the IMU data fusion block 52 may also determine a signal representing the linear acceleration of the personal care device 2 (i.e. the acceleration of the personal care device 2 excluding gravity) from the rotation measurement signal of the gyroscope 8 and the acceleration measurement signal of the accelerometer 7, with the linear acceleration being provided to one or more subsequent blocks in the algorithm (e.g. the IMU location processing block 61). In this case, the acceleration measurement signal enables the direction of gravity to be identified, and the acceleration due to gravity to be removed from the acceleration measurement signal.

The SDMS processing block 54 determines the above ‘first location estimate’ for the electric shaver 2 from the surface-displacement measurement signal received from the surface-displacement sensor 10 and the orientation measurement signal received from the IMU data fusion block 52. In particular, the SDMS processing block 54 derives a 3D angular orientation of a 2D reference plane of the surface-displacement sensor 10 from the orientation measurement signal. Said 2D reference plane is a plane in which the surface-displacement sensor 10 measures the 2D displacement of the electric shaver 2 relative to the user's skin. The SDMS processing block 54 combines the measured 2D displacement of the electric shaver 2 with the derived 3D angular orientation of the 2D reference plane and, thereby, translates the 2D displacement measurements represented by the surface-displacement measurement signal into three dimensions. This results in a raw 3D ‘track’ for the electric shaver over time. The first location estimate is the most recent 3D location sample in the 3D track. This first location estimate is provided to the filtering and anchoring block 62. The first location estimate can also take into account the estimated start location output by the start location estimation block 60.

The IMU location processing block 61 determines the above ‘second location estimate’ for the electric shaver 2 from the device orientation signal. Thus, the IMU location processing block 61 therefore determines the second location estimate using only the measurements from the IMU (accelerometer 6 and gyroscope 8). The second location estimate is output to the filtering and anchoring block 62 and can also be output to the start location estimation block 60. In some embodiments, the IMU location processing block 61 determines the second location estimate from the device orientation signal by using a geometric (3D) model of the subject's face/head, as indicated by 3D model block 63. In particular, the IMU location processing block 61 can determine the second location estimate by calculating the intersection point of the personal care device length axis with the geometric model surface, or by comparing the 3D angular orientation of the shaver with the local surface orientations of the geometric model surface and assuming that the user holds the shaver in a predefined orientation with respect to the local skin surface orientation.

The filtering and anchoring block 62 receives the first location estimate from the SDMS processing block 54, the second location estimate from the IMU location processing block 61, and an indication from the on face detection block 58 that indicates whether the electric shaver is in contact with the skin surface (it should be noted that the connection from ton-face detection block 58 to the filtering and anchoring block 62 is not shown in FIG. 5). Briefly, the filtering and anchoring block 62 determines an anchor location and filters the first location estimate to obtain the next filtered location. The anchor location is the second location estimate combined with knowledge or information about the shaver 2 being on the neck or on the face. Based on this, an anchored second location estimate is determined. The anchored second location estimate is used to filter drift out of the first location estimate using a complementary filter.

In more detail, the filtering and anchoring block 62 can use a latest complementary-filtered location estimate to determine if the electric device is on the face area or in the neck area. The IMU anchor location estimate is then calculated by combining the face/neck location type with the IMU-only location estimate. If the latest filtered location is on the face area, the anchor location is equal to the IMU-only location. If the latest filtered location is in the neck area, the IMU-only location estimate is lowered to the neck area. And this modified/lowered location estimate is used as the anchor location. This anchor location is used to filter the drift out of the surface displacement location estimate (using the complementary filter).

If the indication from the on-face detection block 58 indicates that the electric shaver is not in contact with the skin surface, the filtering and anchoring block 62 determines the location of the electric shaver as the second location estimate. Likewise, if the indication from the on-face detection block 58 indicates that the electric shaver is again in contact with the skin surface after a period of no contact with the skin surface, but before the surface-displacement measurement signal indicates that the electric shaver has moved relative to the skin surface, the filtering and anchoring block 62 determines the location of the electric shaver on the body part as the second location estimate.

If the indication from the on-face detection block 58 indicates that the electric shaver is in contact with the skin surface, and the electric shaver has moved relative to the skin surface in continuous contact therewith since the electric shaver last resumed contact with the skin surface, the filtering and anchoring block 62 determines a filtered location estimate for the electric shaver by combining the first location estimate and the second location estimate using a complementary filter. In some embodiments, the filtering and anchoring block 62 operates such that the filtered location estimate is primarily derived from the first location estimate, with a small correction according to the second location estimate.

The filtered location estimate is output to a beard model projection block 64 which projects the filtered location estimate onto the geometric model 63 of the face (and in particular a beard area of the face and neck) to determine the location of the electric shaver. In some embodiments, block 64 determines the location of the electric shaver from an intersection of the projected filtered location estimate and the geometric model. In some embodiments, the geometric model 63 of the face/beard can be a sphere, but in other embodiments a geometric model 63 that is more representative of the subject's actual face/beard shape can be used. If the location of the personal care device on the neck is to be considered too, the geometric model 63 may include a part representing the neck area, e.g. a cylinder. It will be appreciated that in embodiments where the electric shaver (or other type of personal care device) is used on a body part other than the face/beard, a geometric model 63 suitable for that body part can be used (e.g. a cylindrical model in the case of an arm or leg).

Therefore there is provided improvements in the detection of the location of a personal care device during a personal care operation. In particular, the techniques described herein provide that the location of the personal care device on the body part is determined based on an orientation measurement signal, a surface-displacement measurement signal and a skin contact signal indicating whether the personal care device is in contact with the skin surface of the body part.

Variations to the disclosed embodiments can be understood and effected by those skilled in the art in practicing the principles and techniques described herein, from a study of the drawings, the disclosure and the appended claims. In the claims, the word “comprising” does not exclude other elements or steps, and the indefinite article “a” or “an” does not exclude a plurality. A single processor or other unit may fulfil the functions of several items recited in the claims. The mere fact that certain measures are recited in mutually different dependent claims does not indicate that a combination of these measures cannot be used to advantage. A computer program may be stored or distributed on a suitable medium, such as an optical storage medium or a solid-state medium supplied together with or as part of other hardware, but may also be distributed in other forms, such as via the Internet or other wired or wireless telecommunication systems. Any reference signs in the claims should not be construed as limiting the scope.

1. A personal care device for performing a personal care operation on a subject, the personal care device being configured to determine a location of the personal care device on a body part of the subject, wherein the personal care device comprises:
an orientation sensor configured to measure a three-dimensional, 3D, angular orientation of the personal care device relative to Earth's gravity over time and output a corresponding orientation measurement signal;
characterized in that the personal care device further comprises:
a surface-displacement sensor configured to measure a two-dimensional, 2D, displacement of the personal care device relative to a skin surface of the body part and output a corresponding surface-displacement measurement signal; and
a processing unit configured to determine the location of the personal care device on the body part based on the orientation measurement signal, the surface-displacement measurement signal and a skin contact signal indicating whether the personal care device is in contact with the skin surface of the body part.

2. A personal care device as claimed in claim 1, wherein the personal care device further comprises a skin contact sensor configured to measure whether the personal care device is in contact with the skin surface of the body part and to output the skin contact signal.

3. A personal care device as claimed in claim 1, wherein the processing unit is configured to process the surface-displacement measurement signal to determine the skin contact signal.

4. A personal care device as claimed in claim 1, wherein the surface-displacement sensor is an optical displacement sensor.

5. A personal care device as claimed in claim 1, wherein the orientation sensor comprises a 3-axis accelerometer, a 3-axis gyroscope and a processor configured to determine the 3D angular orientation of the personal care device from output signals of the 3-axis accelerometer and the 3-axis gyroscope and to output the corresponding orientation measurement signal.

6. A personal care device as claimed in claim 1, wherein the processing unit is configured to estimate a starting location of the personal care device on the skin surface of the body part (i) as a default location, or (ii) based on an average starting location detected during previous personal care operations, or (iii) based on the orientation measurement signal.

7. A personal care device as claimed in claim 1, wherein the processing unit is configured to determine the location of the personal care device on or relative to the body part by:
processing the skin contact signal to determine whether the personal care device is in contact with the skin surface of the body part;
if the personal care device is determined (i) not to be in contact with the skin surface, or (ii) to resume contact with the skin surface after a period of no contact with the skin surface and before being moved relative to the skin surface, determining the location of the personal care device on or relative to the body part from the orientation measurement signal; and
if the personal care device is determined to be in contact with the skin surface and after having been moved relative to the skin surface in continuous contact therewith since a last resumption of said contact, determining the location of the personal care device on the body part from the orientation measurement signal and the surface-displacement measurement signal.

8. A personal care device as claimed in claim 7, wherein determining the location of the personal care device on the body part from the orientation measurement signal and the surface-displacement measurement signal comprises:
deriving from the orientation measurement signal a 3D angular orientation of a 2D reference plane of the surface-displacement sensor in which the 2D displacement of the personal care device relative to the skin surface is measured; and
combining the 2D displacement of the personal care device relative to the skin surface represented by the surface-displacement measurement signal with said 3D angular orientation of the 2D reference plane of the surface-displacement sensor to determine a 3D displacement of the personal care device relative to the body part.

9. A personal care device as claimed in claim 7, wherein the processing unit is configured to, if the personal care device is determined to be in contact with the skin surface of the body part and after having been moved relative to the skin surface in continuous contact therewith since a last resumption of said contact:
determine a first location estimate for the personal care device from the surface-displacement measurement signal and the orientation measurement signal;
determine a second location estimate for the personal care device from the orientation measurement signal;
combine the first location estimate and the second location estimate to determine a filtered location estimate;
determine a projection of the filtered location estimate onto a geometric model of the body part; and
determine the location of the personal care device on the body part from said projection.

10. A personal care device as claimed in claim 9, wherein the location of the personal care device on the body part is determined from an intersection of the projection of the filtered location estimate and the geometric model.

11. A personal care device as claimed in claim 9, wherein the first location estimate and the second location estimate are combined using a complementary filter.

12. A personal care device as claimed in claim 1, wherein the body part is a head of the subject, or the head and neck of the subject.

13. A personal care device as claimed in claim 1, wherein the personal care device is an electric shaver.

14. A computer-implemented method of determining a location of a personal care device on a body part of a subject, wherein the personal care device is configured for performing a personal care operation on the subject, the method comprising:
measuring, using an orientation sensor in the personal care device, a three-dimensional, 3D, angular orientation of the personal care device relative to Earth's gravity over time and outputting a corresponding orientation measurement signal;
characterized in that the method further comprises:
measuring, using a surface-displacement sensor in the personal care device, a two-dimensional, 2D, displacement of the personal care device relative to a skin surface of the body part and outputting a corresponding surface-displacement measurement signal; and
determining, by a processing unit, the location of the personal care device on the body part based on the orientation measurement signal, the surface-displacement measurement signal and a skin contact signal indicating whether the personal care device is in contact with the skin surface of the body part.

15. A computer program product comprising a computer readable medium having computer readable code embodied therein, the computer readable code being configured such that, on execution by a suitable computer or processor, the computer or processor is caused to perform the method of claim 14.
